(19) United States
(12) Patent Application Publication
(10) Pub. No.: US 2021/0248552 A1
(43) Pub. Date: Aug. 12, 2021

(54) MONITORING SYSTEM FOR CONTAINER SYSTEMS

(71) Applicant: CARRIER CORPORATION, Palm Beach Gardens, FL (US)

(72) Inventors: Ankit Anand Gupta, Mysuru (IN); Kumar Anup, Mysuru (IN); Robert A. Chopko, Baldwinsville, NY (US); Stella M. Oggianu, Farmington, CT (US)

(21) Appl. No.: 16/973,265

(22) PCT Filed: Aug. 13, 2019
(86) PCT No.: PCT/US2019/046290

§ 371 Date: Dec. 8, 2020

(30) Foreign Application Priority Data
Aug. 14, 2018 (IN) 201811030579

(51) Int. Cl. G06Q 10/08; H02J 50/20; G06Q 50/30

(52) U.S. Cl. CPC G06Q 10/0832; G06Q 50/30; H02J 50/20

(57) ABSTRACT

A monitoring system for a container system that includes a sensor tag disposed on cargo received within an interior space of a container. The sensor tag includes an antenna, a power receiver, and a sensor. The power receiver is arranged to receive power from a power transmitter through the antenna. The sensor in communication with at least one of the antenna and the power receiver. The sensor is arranged to provide a signal indicative of a condition of at least one of the cargo and interior space, responsive to receiving power from the power receiver.

### BACKGROUND

Products such as produce or meat may be shipped relatively long distances and may be placed within refrigerated containers. Monitoring of packed food items inside a refrigerated container may not be real time and individual sensors may need batteries for powering. Battery powered sensors within the refrigerated container may have limited life and reduced performance at low temperatures. These battery powered sensors may also be costly.

### SUMMARY

Disclosed is a container system that includes a container and a monitoring system. The container defines an interior space that is arranged to receive cargo. The monitoring system includes a power transmitter and a sensor tag. The power transmitter is disposed in the interior space of the container. The sensor tag is disposed on the cargo is arranged to provide a signal indicative of a condition of at least one of the cargo and interior space responsive to receiving power from the power transmitter.

Also disclosed is a monitoring system for a container system that includes a sensor tag disposed on cargo received within an interior space of a container. The sensor tag includes an antenna, a power receiver, and a sensor. The power receiver is arranged to receive power from a power transmitter through the antenna. The sensor in communication with at least one of the antenna and the power receiver. The sensor is arranged to provide a signal indicative of a condition of at least one of the cargo and interior space, responsive to receiving power from the power receiver.

These and other advantages and features will become more apparent from the following description taken in conjunction with the drawings.

### BRIEF DESCRIPTION OF THE DRAWINGS

The subject matter which is regarded as the invention of the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a perspective view of a container system; and

FIG. 2 is a schematic view of a sensor tag provided with the container system.

### DETAILED DESCRIPTION

Referring now to the Figures, where the present disclosure will be described with reference to specific embodiments, without limiting same, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Referring to the Figures, a cargo box or a container system 10, such as a refrigerated container or a refrigerated trailer, may be provided with a refrigeration unit that provides conditioned air or cooled air to an interior space 12 of the container system 10. The conditioned air may be conditioned by varying oxygen, carbon dioxide, or ethylene levels or the varying or control of ventilation, temperature, or humidity. The conditioned air or cooled air may be distributed about the interior space 12 by a fan 14 of the refrigeration unit. The interior space 12 is arranged to receive cargo 16, such as sealed containers or other storage devices disposed on a pallet, which may contain goods that are preserved by the provision of conditioned air by the refrigeration system.

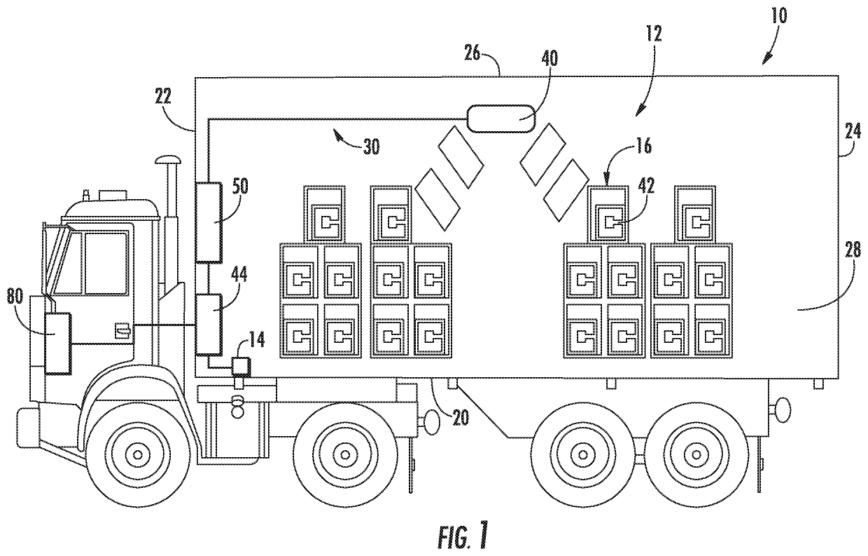

Referring to FIG. 1, the interior space 12 of the container system 10 is defined by a floor 20, a front wall 22, a rear wall 24, a top wall 26, and a pair of side walls 28. The floor 20 extends between proximal ends of the front wall 22, the rear wall 24, and the pair of side walls 28. The floor 20 is spaced apart from and is disposed opposite the top wall 26. The front wall 22 extends between first ends of the floor 20 and the top wall 26. The rear wall 24 is disposed opposite the front wall 22 and extends between second ends of the floor 20 and the top wall 26. The rear wall 24 may define a door that selectively permits access to the interior space 12, however the door may also be defined within or by other walls of the container system 10. The top wall 26 may be a roof or ceiling of the container system 10. The top wall 26 extends between distal ends of the front wall 22, the rear wall 24, and the pair of side walls 28. The top wall 26 is disposed opposite the floor 20. The pair of side walls 28 extend between the floor 20 and the top wall 26 and the pair of side walls 28 extend between the front wall 22 and the rear wall 24.

The cargo 16 may include products such as food items or other items that may be monitored to assure that the products are adequately preserved. Presently, the monitoring of items inside a container may not be real-time and may employ batteries that may have limited life and reduced performance at the lower temperatures within a refrigerated container. The container system 10 includes a monitoring system 30 that provides real-time monitoring of the condition of the cargo 16 and/or the condition of the environment within the interior space 12. The monitoring system 30 includes a power transmitter 40, a sensor tag 42, and a controller 44.

The power transmitter 40 may be disposed within the interior space 12 of the container system 10. The power transmitter 40 may be disposed on the top wall 26 of the container system 10 to provide maximal coverage of the interior space 12. The power transmitter 40 is arranged to receive power from a power supply 50 that is in communication with the controller 44. The power supply 50 may be a DC power supply.

The power transmitter 40 may be arranged to create a RF field to provide power to the sensor tag 42 and is arranged to transmit information to and receive information from the sensor tag 42 wirelessly. The power provided by the power transmitter 40 to the sensor tag 42 avoids the sensor tag 42 from requiring a battery. The power provided by the power transmitter 40 may be a RF field that powers the sensor tag 42. The power transmitter 40 may also be provided with an antenna or other receiver that is arranged to receive and/or transmit data, information, or a signal to/from the sensor tag 42. The power transmitter 40 may transmit the data, information, or the signal from the sensor tag 42 to a display interface or to a remote server through a communication network.

The sensor tag 42 may be disposed on the cargo 16. The sensor tag 42 may be a plug-and-play unit that is placed within a container or package that may constitute the cargo 16. The sensor tag 42 may be arranged as a RF power receiver, an energy storage device, a parameter monitor, and a wireless communication device. The sensor tag 42 may also be an actuator or any device requiring power.

The sensor tag 42 is in wireless communication with the power transmitter 40 and/or the controller 44. Multiple sensor tags may be powered by the power transmitter 40 and the multiple sensor tags may provide signals that are received by the power transmitter 40 and/or the controller 44. Each signal may include a unique identifier as to which item(s) of the cargo 16 are associated with each signal. In such an arrangement, the sensor tags 42 provide real-time information as to the condition of individual items of the cargo 16 or the environment proximate individual items of the cargo 16.

The sensor tag 42 is arranged to provide a signal indicative of a condition of at least one of the cargo 16 upon which the sensor tag 42 is disposed and the interior space 12, responsive to receiving power from the power transmitter 40. The condition of at least one of the cargo 16 and the interior space 12 may be a cargo temperature, a temperature of the interior space 12 proximate the cargo 16, humidity within the interior space 12, a concentration of a refrigerant within the interior space 12, a concentration of at least one of ethylene, carbon dioxide (CO2), and oxygen (O2) within the interior space 12, as well as other parameters or measurable values.

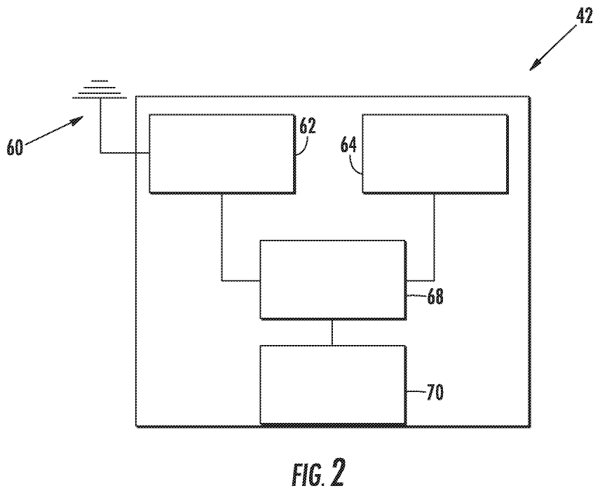

Referring to FIG. 2, the sensor tag 42 includes an antenna 60, a power receiver 62, and a sensor 64. The antenna 60, the power receiver 62, and the sensor 64 may all be disposed within a sensor tag housing 66.

The antenna 60 may be a wireless communication device that is arranged to receive power from the power transmitter 40, direct the power to the power receiver 62, and transmit a signal back to the power transmitter 40 and/or the controller 44. The antenna 60 is also arranged to provide the signal from the sensor 64 to the power transmitter 40, responsive to the power receiver 62 receiving power from the power transmitter 40 through the antenna 60. The antenna 60 may be at least partially disposed within the sensor tag housing 66 or may extend from the sensor tag housing 66.

The power receiver 62 is arranged to receive power from the power transmitter 40 through the antenna 60. The power receiver 62 is arranged to provide power to the sensor 64. The power receiver 62 may be a RF power receiver that receives RF power from the power transmitter 40. However, other forms of wireless power transmission are also contemplated besides RF power. For example, the power receiver 62 may be arranged as an energy harvesting device that is arranged to harvest electromagnetic energy from the fan 14.

In such an arrangement, the antenna 60 and the power receiver 62 define a remotely powered communication system. The remotely powered communication system provides communication, sensing, and actuating functionality responsive to receiving power from a remote power source, e.g. the power transmitter 40, without an internal power source. The remotely powered communication system enables the sensor tag 42 to be robust and less influenced by the environment within the interior space 12.

The sensor 64 is in communication with and is connected to at least one of the antenna 60 and the power receiver 62. The sensor 64 is arranged to monitor the condition of at least one of the cargo 16 and the interior space 12. The power received by the sensor 64 enables the sensor 64 to sense, communicate, and/or actuate. The sensor 64 may be provided as a plurality of sensors or a sensor array that is arranged to monitor various conditions or parameters.

The sensor tag 42 may be provided with a controller 68 that is in communication with the antenna 60, the power receiver 62, and the sensor 64. The controller 68 may be disposed within the sensor tag housing 66. The controller 68 is arranged to manage power delivery between the sensor 64 and the power receiver 62 and communications between the power receiver 62 and the sensor 64. The controller 68 may control the timing of communications of the sensor 64.

The controller 68 or the controller 44 may include memory to store and process sensor data or information. The information communicated may be data from the sensor 64 or data that may have been pre-processed locally.

The controller 68 may include memory to store data should the power be less than a threshold, and store the monitored parameters associated with the signal until sufficient power is available to transmit the data/signal to the power transmitter 40 and/or the controller 44 or may transmit the signal to a remote server. The controller 68 may be provided with analytics to make decisions based on the sensor data. The controller 68 is also arranged to manage power delivery between an energy storage device 70 and the sensor 64. The energy storage device 70 may be arranged to store at least a portion of the power that is received from the power transmitter 40 and deliver a portion of the power to the sensor 64.

The controller 44 may be provided as part of the refrigeration unit or may be provided as a separate controller that is in communication with the power transmitter 40, the power supply 50, and/or the fan 14. The controller 44 is provided with input communication channels that are arranged to receive the signal from the sensor tag 42, via the power transmitter 40. The controller 44 is provided with output communication channels that are arranged to provide signals or commands to the power transmitter 40 to provide power to the sensor tag 42 responsive to a request to monitor or assess the condition of at least one of the cargo 16 and the interior space 12. The output communication channels of the controller 44 are arranged to output for display an indicator, via a display interface 80, indicative of the condition of at least one of the cargo 16 and the interior space 12. The display interface 80 may be remotely located from the refrigerated container.

The controller 44 is provided with at least one processor that is programmed to perform control logic, control algorithms, or functions to command the power transmitter 40 to provide power to the sensor tag 42, as well as to interpret or display information associated with the signal provided by the sensor tag 42.

In at least one embodiment, controller 44 is arranged to query as to the presence of cargo 16 within the interior space 12. Should the power transmitter 40 attempt to provide power to the sensor tag 42 and no signal is received by the power transmitter 40 from the sensor tag 42, the controller 44 is programmed to output for display an indicator, indicative of the absence of cargo 16 within the interior space 12. If the power transmitter 40 attempts to provide power to the sensor tag 42 and a signal is received by the power transmitter 40 from the sensor tag 42, the controller 44 is programmed to output for display an indicator, indicative of the presence of cargo 16 within the interior space 12 and/or the condition of the cargo 16.

The monitoring system 30 provides an improved method of sensing inside the cargo 16. The monitoring system 30 enables remote access to the real-time data provided by the sensor tag 42 while also being robust to the environment within the interior space 12.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description.

What is claimed is:

1. A container system, comprising:
a container defining an interior space that is arranged to receive cargo; and
a monitoring system, comprising:
a power transmitter disposed in the interior space of the container, and
a sensor tag disposed on the cargo, the sensor tag being arranged to provide a signal indicative of a condition of at least one of the cargo and interior space responsive to receiving power from the power transmitter.

2. The container system of claim 1, wherein the condition of at least one of the cargo or interior space is cargo temperature, a temperature of the interior space proximate the cargo, humidity, concentration of a refrigerant within the interior space, a concentration of at least one of ethylene, carbon dioxide, and oxygen within the interior space.

3. The container system of claim 1, further comprising:
a refrigeration unit having a controller that is in communication with at least one of the power transmitter and the sensor tag.

4. The container system of claim 3, wherein the power transmitter is arranged to at least one of transmit RF power and receive the signal.

5. The container system of claim 4, wherein the sensor tag includes:
a power receiver that is arranged to receive power from the power transmitter; and
a sensor that is arranged to monitor the condition of at least one of the cargo and interior space and provide the signal to the power transmitter.

6. The container system of claim 5, wherein the sensor tag further includes a controller that is programmed to store monitored parameters associated with the signal.

7. The container system of claim 3, wherein the refrigeration unit has a fan that is arranged to direct conditioned air into the interior space.

8. A monitoring system for a container system, comprising:
a sensor tag disposed on cargo received within an interior space of a container, the sensor tag comprising:
an antenna;
a power receiver that is arranged to receive power from a power transmitter through the antenna; and
a sensor in communication with at least one of the antenna and the power receiver, the sensor being arranged to provide a signal indicative of a condition of at least one of the cargo and interior space, responsive to receiving power from the power receiver.

9. The monitoring system of claim 8, wherein the antenna is arranged to provide the signal to the power transmitter, responsive to the power receiver receiving power from the power transmitter.

10. The monitoring system of claim 8, wherein the sensor tag further comprising:
an energy storage device arranged to store power that is received from the power transmitter; and
a controller programmed to manage power between the energy storage device and the sensor.

11. The monitoring system of claim 8, wherein the monitoring system further comprising:
the power transmitter; and
a controller in communication with the power transmitter.

12. The monitoring system of claim 11, wherein the controller is programmed to command the power transmitter to provide power to the sensor tag.

13. The monitoring system of claim 12, wherein the controller is programmed to output for display an indicator indicative of the condition of at least one of the cargo and interior space, via a display interface, responsive to the power transmitter receiving the signal.
